(19) United States
(12) Patent Application Publication
(10) Pub. No.: US 2026/0346551 A1
(43) Pub. Date: Nov. 5, 2026

(54) Method for Producing a Carrier Part, Method for Producing an Interior Paneling Part, Method for Replacing a Surface Covering and an Interior Paneling Part

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Johann GASSLHUBER, Buch am Erlbach (DE)

(21) Appl. No.: 19/661,844

(22) Filed: Apr. 29, 2026

(30) Foreign Application Priority Data
Apr. 30, 2025 (DE) 10 2025 116 638.2

(51) Int. Cl. B29C 65/00; B29L 31/30

(52) U.S. Cl. CPC B29C 66/30321; B29C 66/21; B29C 66/7212; B29L 2031/3005

(57) ABSTRACT

A method for producing a carrier part made of fiber-reinforced plastic, in which natural fibers are embedded in a plastics matrix, includes the steps of: applying pressure and/or temperature to a semifinished product made of fiber-reinforced material; forming at least one protruding region on a surface of the carrier part, after or during application of pressure and/or temperature to the semifinished product. The protruding regions are formed from injectable plastics material. The method is used for producing an interior paneling part, or for replacing a surface covering of an interior paneling part.

### CROSS REFERENCE TO RELATED APPLICATION

This application claims priority under 35 U.S.C. §119 from German Patent Application No. 10 2025 116 638.2, filed Apr. 30, 2025, the entire disclosure of which is herein expressly incorporated by reference.

### BACKGROUND AND SUMMARY

The present invention relates to a method for producing a carrier part, to a method for producing an interior paneling part, to a method for replacing a surface covering, and to an interior paneling part.

In contemporary vehicle construction, surfaces in the vehicle interior or in the passenger compartment of motor vehicles are provided with decorative elements in order to create an appealing visual impression for the occupants of the vehicle. In this context, it has become customary to adhesively bond decorative elements, for example in the form of films with the visual appearance of wood or carbon, to a plastics carrier. In addition, it is also known to mount skins made of leather or artificial leather on carrier structures using press laminating methods, in order to create the visual appearance of leather. In this laminating operation, the films or the skins are connected to the underlying supporting structure in a materially bonded manner using an adhesive. The heat needed to activate the adhesive is introduced into the adhesive joint through the skin via a hot press punch of the press laminating tool by way of contact heat or radiation heat. This cures the adhesive during the laminating method and connects the film or the skin to the supporting structure.

Known motor vehicles comprise interior components which are usually designed from structuring basic bodies and surface coverings which enable a desired visual appearance and/or feel. A multiplicity of different surface coverings for the manufacture of interior components are known. The known surface coverings in the manufacture of motor vehicles, such as fabrics, leather, films, knitted fabrics and/or woven fabrics, usually require different methods and devices for fastening the respective surface covering to a corresponding structural component or carrier part of the interior component.

Known methods and devices for fastening comprise screw connections, plug connections and/or adhesive connections between the surface coverings and the respective structural component. The disadvantageous feature common to screw and plug connections is that they represent a high cost factor and/or the fastening is only carried out in a punctiform manner. Furthermore, screw and plug connections have the disadvantage of a high installation space requirement and/or require higher material thicknesses of the structural component. Alternatively, areal adhesive connections or laminating processes for producing a connection between the surface coverings and the respective structural component are known. However, known adhesive connections usually disadvantageously require drying and/or waiting times and also complex methods for ensuring the surface tension of the surface coverings. In addition, the known adhesives disadvantageously have limited times for use once opened. Separation of the various materials of the interior component for an advantageous circular economy is not possible or is possible only with high expenditure of time and cost when using areal adhesive connections and/or laminating processes. Reuse of the materials in a circular economy is thus usually not achievable when using areal adhesive connections and/or laminating processes.

Taking this prior art as a starting point, the object of the present invention is to provide a method and an interior paneling part with which the disadvantages of the prior art are overcome. It is a particular object of the invention to provide a method and an interior paneling part with which mounting or removal of a surface covering is achievable in a particularly simple manner.

This object is achieved by means of a method and a device according to the features of the independent claims. Further embodiments are specified in the dependent claims that refer back to the independent claims.

To achieve this object, the invention teaches a method for producing a carrier part made of fiber-reinforced plastic, in which natural fibers are embedded in a plastics matrix, comprising the steps:
applying pressure and/or temperature to a semifinished product made of fiber-reinforced material;
forming at least one protruding region of a surface of the carrier part, during or after application of pressure and/or temperature to the semifinished product.

Furthermore, the protruding regions may be formed from injectable plastics material. In other words, the protruding regions are molded or injected onto the carrier part by means of injection molding methods. The protruding regions are thus made of a homogeneous plastic and have no reinforcing fibers.

Natural fibers within the meaning of this invention include in particular hemp, sisal, kenaf and basalt. The protruding regions are therefore specifically shaped fastening geometries, which are subsequently injected onto the carrier part. In alternative embodiments of the method, the fastening geometries may be injected during the creation of the carrier part.

Furthermore, a multiplicity of protruding regions may be created, with protruding regions of a first type and protruding regions of a second type.

The protruding regions of the first type and the protruding regions of the second type may differ by their local position on the surface of the carrier part, by the height in relation to the surface of the carrier part and/or by their geometric design in terms of shape and/or contour.

The protruding regions may be formed in a fixing region and/or edgefold portion of the carrier part. The edgefold portion of the carrier part corresponds to a region of the carrier part in which the surface covering is folded around an edge of the carrier part. In this region, the surface covering is folded substantially by an angle of 90° or 180° around the edge of the carrier part.

In a second aspect, the invention relates to a method for producing an interior paneling part comprising the steps:
providing a surface covering and a carrier part, the carrier part being produced by an above-described method,
arranging the surface covering on the carrier part,
joining the surface covering and the carrier part by introducing pressure and/or temperature by means of a joining punch. Furthermore, during joining, protruding regions of the carrier part can be connected to the surface covering in a materially bonded manner.

In this case, only protruding regions of a first type are connected to the surface covering.

In a third aspect, the invention relates to a method for replacing a surface covering on an interior paneling part, produced by an above-described method, comprising the steps:
severing the materially bonded connection between the surface covering and the carrier part,
removing the surface covering,
arranging a new surface covering on the carrier part,
joining the new surface covering and the carrier part by introducing pressure and/or temperature by means of a joining punch. Furthermore, during joining, protruding regions of the carrier part can be connected to the surface covering in a materially bonded manner.

When joining the new surface covering to the carrier part, protruding regions of the second type of the carrier part can be connected to the new surface covering in a materially bonded manner.

In a fourth aspect, the invention relates to an interior paneling part comprising:
a carrier part, protruding regions being provided on the carrier part, and
a surface covering which is at least partially in touching contact with a surface of the carrier part. The surface covering can be connected to the carrier part in a materially bonded manner by way of the protruding regions.

The carrier part may have a multiplicity of protruding regions, with protruding regions of a first type and protruding regions of a second type, the surface covering being connected in a materially bonded manner exclusively by means of protruding regions of the first type.

Furthermore, the carrier part may have a multiplicity of protruding regions, with protruding regions of a first type and protruding regions of a second type, the surface covering being connected in a materially bonded manner exclusively by means of protruding regions of the second type.

The interior paneling part should preferably be understood to mean at least one portion of a roof liner, of a door paneling, of a cockpit paneling, in particular of an instrument panel, of an armrest, of a shift knob trim and/or of a seat cover. Further embodiments of the interior paneling part are also contemplated and possible. In addition to interior paneling parts of passenger compartments in motor vehicles, the invention can also be used in luggage compartment parts, engine compartment parts, aircraft parts, aerospace parts, train parts, motorcycle parts, bicycle parts, ship cladding parts, residential components etc.

In the context of the invention, the surface covering should preferably be understood as an areal, two-dimensional or three-dimensional covering for an interior paneling part for a motor vehicle. Preferably, the joining method according to the invention allows a multiplicity of different surface coverings to be joined to the structural component. The structural component should preferably be understood as a basic body of the interior component and enables a structural design of the interior component.

The advantages of the invention will be briefly summarized below. The basic idea of the present invention is to provide several types of connecting elements or protruding regions that differ from one another. Advantageous arrangement of these protruding regions or these connecting elements on the carrier part, the protruding regions differing in terms of height, location, geometry, offset, position, etc., makes it possible to create a selective and thus partial connection between the surface covering and the carrier part. The protruding regions may, for example, be arranged at least partially in two rows. The height of the tip, i.e. the greatest elevation of a protruding region in relation to the surface of the carrier part, can be different heights depending on the embodiment of the connecting element. Surface coverings are connected to the carrier part by selective use of protruding regions, connecting elements of the first and second generation of use being used on the carrier part. During the initial fitting, in which a very first surface covering is connected to the carrier part, the surface covering is welded to particular connecting elements. These connecting elements are worn after welding. These are first-generation connecting elements. When replacing the surface covering, for example in the course of a desired change or a repair, the connection between the surface covering and the carrier part is released and a new surface covering is connected to the carrier part. The new surface covering is connected to the carrier part by welding, second-generation connecting elements being used. In an analogous manner, it is possible to proceed with a third to n-th surface covering, which are then connected respectively to third-generation or n-th-generation connecting elements.

Components produced according to the invention can be easily separated into their constituent parts at the end of the vehicle life cycle, as a result of which a high degree of reusability can be achieved. Reuse of the materials in a circular economy is therefore readily achievable, it being possible to implement separation into materials of the same type, compliance with future recycling quotas, resource savings, etc.

In addition, a changeability of the decorative element can be made possible. This makes it possible to achieve high degrees of freedom for design and material combinations.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows by way of example a known carrier part;

FIG. 2 is a cross section through a carrier part illustrated in simplified form;

FIG. 3 is a cross section through the carrier part from FIG. 2 with a surface covering arranged thereon;

FIG. 4 is a cross section through the arrangement from FIG. 3 with a surface covering connected thereto in a materially bonded manner;

FIG. 5 is a cross section through the carrier part from FIG. 4;

FIG. 6 is a cross section through the carrier part from FIG. 5 with a surface covering arranged thereon; and

FIG. 7 shows exemplary arrangements of protruding regions.

### DETAILED DESCRIPTION OF THE DRAWINGS

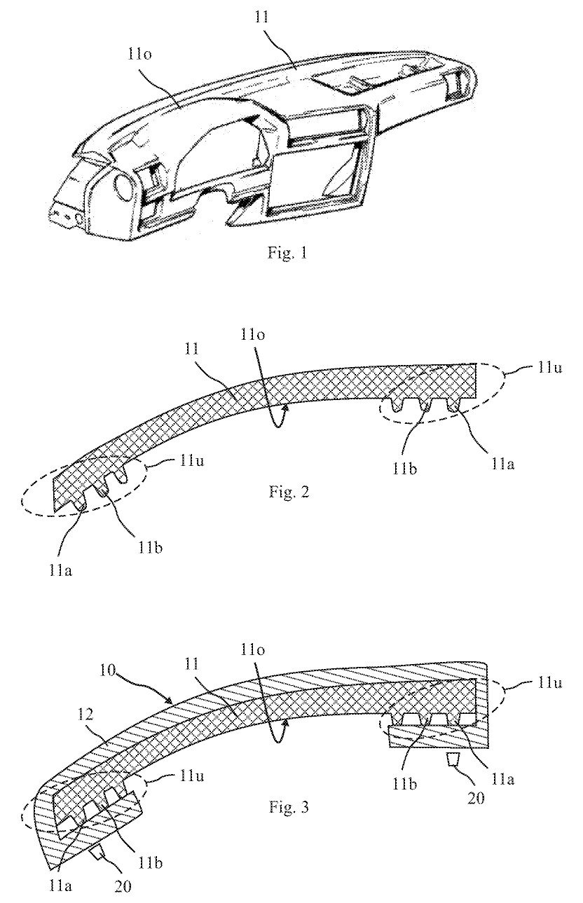

FIG. 1 shows by way of example an instrument panel carrier 11, which will serve as carrier part 11 for the purpose of explaining the method. As an alternative to the instrument panel carrier illustrated, all other carrier parts for paneling parts located in the interior, such as glove compartments, central armrests, panels, armrests in the door panelings, door panelings, roof liners, etc., may also serve as carrier part 11. This instrument panel carrier 11 has a surface 11o which can be at least partially covered using a surface covering. As illustrated in FIG. 1, this surface may concern merely a portion, such as the upper surface of the binnacle of what is known as the instrument cluster. The surface 11o to be covered may, however, also be that part of the surface of the carrier part 11 which would be visible to an occupant of the vehicle in the interior of the vehicle. Furthermore, alternatively, the surface 11o may also comprise the entire surface of the carrier part 11, in which case regions of the carrier part 11 that are not visible to an occupant of the vehicle would also be laminated.

FIG. 2 shows a cross section through a carrier part 11 illustrated in highly simplified form. The carrier part 11 has a side facing toward the interior of the passenger compartment and illustrated in FIG. 2 in the form of an upper side. The lower side of the carrier part 11 in the figure is a side facing away from the passenger compartment. End sides are provided in a region of transition from the facing side to the side that faces away. These end sides and the peripheral region, the side facing away from the vehicle interior, form an edgefold region 11u. When a surface covering is arranged on the carrier part 11, surface material is folded over, such that the edgefold region 11u is covered. To save surface material, the entire rear side, i.e. the side of the carrier part 11 facing away from the passenger compartment, does not have to be covered with surface material, but rather can remain free. In other words, on a side of the carrier part facing away from the vehicle interior, there is only surface material in the edgefold region 11u.

A fiber-reinforced semifinished product is used to produce the carrier part 11. Preferably, semifinished products in which natural fibers are arranged in a polypropylene matrix are suitable. Natural fibers are usually obtained from natural sources, in particular from plants, animals or minerals. Natural fibers include in particular hemp, sisal, basalt, etc. The natural fiber semifinished product, also called NFPP semifinished product, is formed such that its outer contour or shape corresponds to the outer contour or shape of the desired component. In this state, pressure and/or temperature is applied to the semifinished product, such that the polypropylene matrix cures and permanently assumes the desired shape. After or during the forming and/or curing of the semifinished product, protruding regions 11a, 11b are created. The protruding regions 11a, 11b are molded or injected onto the carrier part by means of injection molding methods. The protruding regions are thus made of a homogeneous plastic and have no reinforcing fibers. As an alternative thereto, these protruding regions may also be formed as pure resin geometries, in which there is only polypropylene matrix material, but no natural fibers.

The protruding regions 11a, 11b may be formed as cones, truncated cones, in a mushroom shape, cylinder blocks, cubes or combinations thereof.

For the production of an interior paneling part 10, a surface covering 12 is applied to the carrier part 11. The surface covering 12 is placed on the side of the carrier part 11 facing toward the vehicle interior, such that it is in touching contact therewith and folded over at the peripheral regions of the carrier part 11, with the result that, in the edgefold region 11u, the surface covering 12 is also in touching contact with the surface 11o of the carrier part 11.

FIG. 3 shows the intermediate state of the process for producing an interior paneling component 10 after the surface covering 12 has been applied to the carrier part 11. As illustrated in FIG. 3, the surface covering 12 completely overlaps all the protruding regions 11a, 11b, specifically both in the edgefold region 11u illustrated on the left-hand side in the figure and in the edgefold region 11u of the carrier part 11 illustrated on the right-hand side in the figure. Contrary to the variant illustrated in FIG. 3, in the edgefold region 11u, the surface covering may also overlap only one protruding region, for example the protruding region 11a, on each side of the carrier part 11.

Using a welding device 20, the surface covering 12 is welded to the protruding region 11a and thereby connected in a materially bonded manner. In addition to friction welding, ultrasonic welding in particular has proven to be practicable. The intermediate state of this step in the production of the interior paneling component 10 is illustrated in FIG. 4. After ultrasonic welding, the height of the protruding region 11a that is connected to the surface covering 12 is reduced. Contrary to the variant illustrated in FIG. 4, it is also possible for the protruding region 11b, instead of the protruding region 11a, to be connected to the surface covering 12 in a materially bonded manner. The height of the protruding region refers to the distance to the lateral surface of the carrier part 11 facing away from the passenger. FIG. 4 thus shows a cross section through a finished interior paneling part 10. Owing to signs of wear or damage or purely for visually decorative reasons, there may be the need to change the surface covering 12. In the prior art, in which the surface covering is laminated or adhesively bonded onto the carrier part, an exchange of the surface covering 12 would be possible only with great difficulty. Consequently, the entire interior paneling part would have to be replaced.

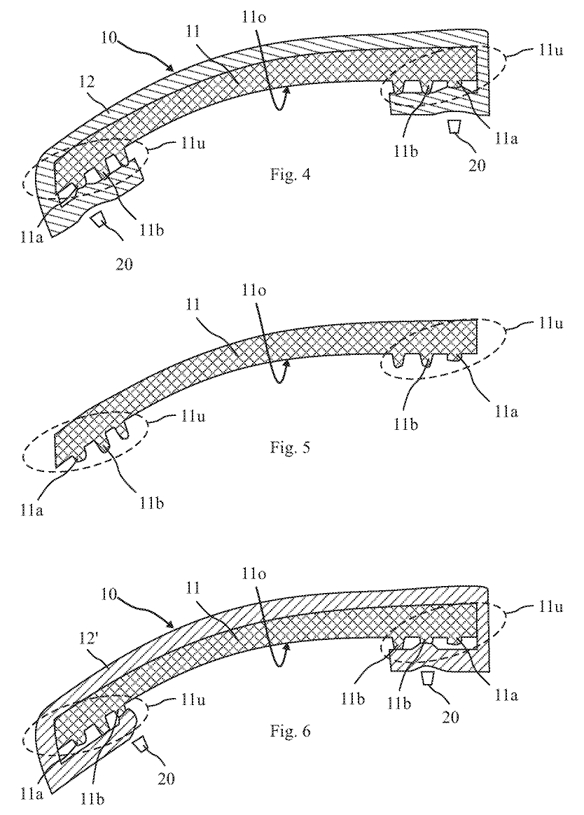

According to the present invention, in order to change the surface covering 12, the materially bonded connection between the surface covering 12 and the first protruding region 11a can be severed. The easiest way to do this is to mechanically destroy the connection. The surface covering 12 can then be pulled off from the carrier part 11 and removed. The state after this intermediate step is illustrated in FIG. 5. As can be seen therefrom, the first protruding region 11a has a lower height than other protruding regions 11b of the carrier part 11. The first protruding regions 11a are thus consumed and can no longer be used for mounting a new surface covering 12 or their use results in significantly lower adhesion forces in the materially bonded connection.

A new surface covering 12’ can then be applied to the carrier part 11. The application is carried out analogously to the application of the first, original surface covering 12, as described above. For fastening the surface covering 12 to the carrier part 11, a welding tool 20, for example a sonotrode, is then used to create a materially bonded connection to the second protruding region 11b and the new or replacement surface covering 12’.

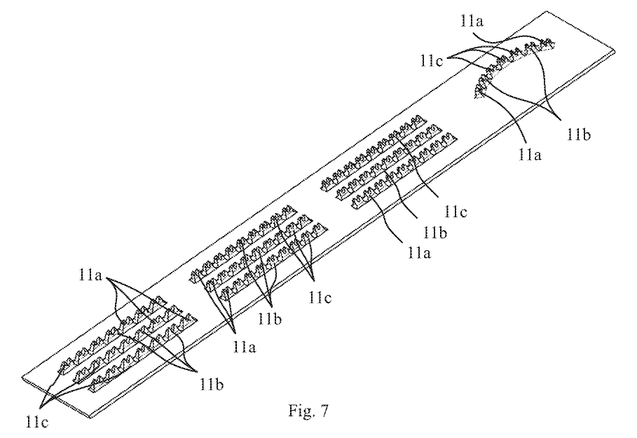

FIG. 7 illustrates four different arrangement fields of fastening elements 11a, 11b, 11c on a test object. In the first arrangement from the right in the figure, the fastening elements are arranged in an arc. Two first-generation fastening elements 11a are provided at the outermost periphery of the arc. Toward the center of the arc, there is a second-generation fastening element 11b for each first-generation fastening element 11a. Three third-generation fastening elements 11c are provided in the center of the arc. From earlier generation to later generation, the surface covering 12 is connected to fastening elements that are locally closer together. Since the distance between the fastening elements used decreases from generation to generation, it is advantageous to use a plurality of fastening elements for later generations - in this case, for example, the third generation. As a result, an almost equally firm connection of the surface covering 12, 12’ to the carrier part 11 can be achieved across several generations.

In the second arrangement from the right in the figure, the fastening elements are arranged in three linear rows, the central row being formed from second-generation fastening elements 11b. Above it, a row is formed from first-generation fastening elements 11a. Below it, a row is formed from third-generation fastening elements 11c.

In the third arrangement from the right in the figure, the fastening elements are arranged in three linear rows. Fastening elements of a generation are not only arranged in one row, but are located in each row. For example, first-generation fastening elements are arranged in the upper, the central and the lower rows, specifically substantially in alignment.

In the fourth arrangement from the right in the figure, the fastening elements are also arranged in three linear rows. Fastening elements of a generation are arranged distributed across all three rows. The arrangement of the fastening elements is chosen in such a way that the fastening elements of one generation (11a) have the same distances to one another or the same arrangement form as fastening elements of another generation (11b, 11c).

Although all the fastening elements have the same shape, contour, height, etc., in FIG. 7, in embodiments that are not illustrated the fastening elements may also have other shapes, contours, heights, etc. and/or differ from one another by different shape, contour, height.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a carrier part made of fiber-reinforced plastic, in which natural fibers are embedded in a plastics matrix, the method comprising the steps of:
applying pressure and/or temperature to a semifinished product made of the fiber-reinforced material; and
forming, from injectable plastics material, at least one protruding region of a surface of the carrier part, during or after application of the pressure and/or temperature to the semifinished product.

2. The method according to claim 1, wherein a multiplicity of protruding regions are formed comprising protruding regions of a first type and protruding regions of a second type.

3. The method according to claim 2, wherein the protruding regions of the first type and the protruding regions of the second type differ by:
local position on the surface of the carrier part,
height in relation to the surface of the carrier part, and/or
geometric design.

4. The method according to claim 2, wherein
the multiplicity of protruding regions are formed in a fixing region and/or edgefold portion of the carrier part.

5. A method for producing an interior paneling part, the method comprising the steps of:
providing a surface covering;
providing a carrier part produced by the method according to claim 2;
arranging the surface covering on the carrier part;
joining the surface covering and the carrier part by introducing pressure and/or temperature via a joining punch,
wherein, during the joining, protruding regions of the carrier part are connected to the surface covering in a materially bonded manner.

6. The method according to claim 5, wherein
only protruding regions of the first type are connected to the surface covering.

7. A method for replacing a surface covering on an interior paneling part, the method comprising the steps of:
producing the interior paneling part according to the method of claim 6;
severing the materially bonded connection between the surface covering and the carrier part;
removing the surface covering;
arranging a new surface covering on the carrier part;
joining the new surface covering and the carrier part by introducing pressure and/or temperature via a joining punch,
wherein, during the joining, protruding regions of the carrier part are connected to the surface covering in a materially bonded manner.

8. The method according to claim 7, wherein
when joining the new surface covering to the carrier part, protruding regions of the second type of the carrier part are connected to the new surface covering in a materially bonded manner.

9. An interior paneling part, comprising:
a carrier part, wherein protruding regions are provided on the carrier part; and
a surface covering which is at least partially in touching contact with a surface of the carrier part,
wherein the surface covering is connected to the carrier part in a materially bonded manner by way of the protruding regions.

10. The interior paneling part according to claim 9, wherein
the carrier part has a multiplicity of protruding regions, with protruding regions of a
first type and protruding regions of a second type,
the surface covering is connected in a materially bonded manner exclusively by protruding regions of the first type.

11. The interior paneling part according to claim 9, wherein
the carrier part has a multiplicity of protruding regions, with protruding regions of a first type and protruding regions of a second type,
the surface covering is connected in a materially bonded manner exclusively by protruding regions of the second type.
